(19) United States
(12) Patent Application Publication
(10) Pub. No.: US 2026/0094131 A1
(43) Pub. Date: Apr. 2, 2026

(54) Machine-Learning Method for Detecting Data Change Points in a Dynamic Social Network

(71) Applicants: City University of Hong Kong, Hong Kong (HK); Huaiyin Institute of Technology, Huaian City (CN)

(72) Inventors: Rui LUO, Hong Kong (HK); Jie BAO, Huaian City (CN); Suqun CAO, Huaian City (CN)

(21) Appl. No.: 18/898,731

(22) Filed: Sep. 27, 2024

(51) Int. Cl. G06Q 50/00; G06V 10/762

(52) U.S. Cl. CPC G06Q 10/40; G06V 10/7635

(57) ABSTRACT

The present invention provides a machine-learning method for detecting data change points in a dynamic social network. The method comprises: capturing a sequence of graph snapshots of a graph representing the dynamic social network; extracting data features from each graph snapshot; applying a sliding-window statistical analysis on the extracted data features of the sequence of graph snapshots to detect a first set of change points; applying a local outlier factor algorithm on the extracted data features of the sequence of graph snapshots to detect a second set of change points; combining the first and second sets of change points to form an output set of change points for the sequence of graph snapshots. The provided method can effectively handle the high-dimensional complex network data, particularly in dynamic environments, to provide more accurate and comprehensive information.

### FIELD OF THE INVENTION

The present invention generally relates to the technical field of high-dimensional dynamic graph structure data change point detection. More specifically the present invention relates to machine-learning method for detecting data change points in a dynamic social network based on matrix decomposition.

### BACKGROUND OF THE INVENTION

In recent years, the proliferation of social network data has significantly augmented the demand for sophisticated statistical network analysis in diverse domains encompassing socializing, information sharing, and collaborative work. Researchers are increasingly interested in delving into the dynamics of social networks to gain profound insights into social phenomena and to accurately predict future events. This pursuit not only enhances our understanding of human behavior and social interactions but also holds immense potential for impactful applications in fields like social media, public health and transportation.

Detecting changes in social network structures is crucial, as it reveals emerging trends and patterns that offer profound insights into the intricate dynamics of social interactions. These insights can uncover various phenomena, including the emergence of new social groups, the dissemination of social influence, and shifts in social behaviors. Notably, change point detection is a pivotal technique in community detection and the identification of echo chamber, which, if left unchecked, can amplify biases and propagate misinformation within online social networks. By integrating changes in temporal patterns into segregation models, we can better understand and ultimately mitigate the effects of echo chambers on online social networks.

Existing change point detection methods can be broadly categorized into three main groups: non-parametric methods, parametric methods, and Bayesian methods. Non-parametric methods typically utilize statistical or analytical evaluation to identify abrupt changes or outliers in data sequences. For example, the cumulative sum (CUSUM) method calculates the cumulative sum of the data sequence and detects changes based on variations in this cumulative sum. This method is straightforward and does not require assumptions about the data distribution, but it may be sensitive to trends in the data and affected by high noise levels.

In contrast to non-parametric methods, parametric methods typically rely on assumptions about the specific distribution of the data, such as the Gaussian or Poisson distributions. These methods then utilize statistical techniques, such as regression analysis or Markov models, to detect change points in the data. However, the accuracy of parametric methods often depends on the validity of these assumptions, and discrepancies between the assumed and actual data distributions can lead to biases in the detection results.

Bayesian methods, which are grounded in Bayesian statistical theory, typically require assumptions about the prior distributions of the data and update these assumptions based on the observed data. These methods involve iterating over the data observations and updating models to achieve accurate detection and localization of change points. While this approach can handle complex data distributions and uncertainties, it often comes with a higher computational complexity.

### SUMMARY OF THE INVENTION

It is one objective of the present invention to address the aforementioned challenges to provide change point detection method that can effectively handle the high-dimensional complex network data, particularly in dynamic environments, to provide more accurate and comprehensive information.

According to one aspect of the present invention, a machine-learning method for detecting data change points in a dynamic social network is provided. The method comprises: capturing a sequence of graph snapshots of a graph representing the dynamic social network; extracting data features from each graph snapshot; applying a sliding-window statistical analysis on the extracted data features of the sequence of graph snapshots to detect a first set of change points; applying a local outlier factor algorithm on the extracted data features of the sequence of graph snapshots to detect a second set of change points; combining the first and second sets of change points to form an output set of change points for the sequence of graph snapshots. The data features are extracted from each graph snapshot by: selecting a plurality of views of the graph snapshot; computing and normalizing a plurality of adjacency matrices corresponding to the selected views respectively; performing a multi-hop nonnegative matrix factorization on the plurality of normalized adjacency matrices to obtain a snapshot-based feature matrix; and extracting the data features from the snapshot-based feature matrix.

In some embodiments, the multi-hop nonnegative matrix factorization is performed to obtain the snapshot-based feature matrix by: decomposing the plurality normalized adjacency matrices concurrently to obtain a plurality of view-based feature matrices containing feature information of the graph snapshot at the selected views respectively; clustering the plurality of view-based feature matrices to obtain a consensus matrix; and regulating the consensus matrix to obtain the snapshot-based feature matrix.

The present invention provides a novel approach that integrates non-negative matrix decomposition with the utilization of the Euclidean norm to measure distances between matrixs. By considering that node information in graph snapshots changes over time, graph matrix information is integrated from different selected views to ensure the effectiveness and accelerate optimization in dynamic feature extraction. By leveraging merits of sliding window-based statistical analysis and local outlier factor detection algorithm, the present invention can capture more underlying information from graph-structured network data while maintaining favorable properties and achieving higher accuracy compared to most existing social network change point detection methods.

### BRIEF DESCRIPTION OF THE DRAWINGS

Embodiments of the invention are described in more details hereinafter with reference to the drawings, in which:

FIG. 1 shows a process flowchart of a machine-learning method for detecting data change points in a dynamic social network according to some embodiments of the present invention;

FIG. 2 shows a process flowchart on how data features are extracted according to some embodiments of the present invention;

FIG. 3 shows a process flowchart on multi-hop nonnegative matrix factorization is performed to obtain snapshot-based feature matrix according to some embodiments of the present invention;

FIG. 4 shows a process flowchart on how sliding-window statistical analysis is applied to detect change points according to some embodiments of the present invention; and

FIG. 5 shows a process flowchart on how local outlier factor detection algorithm is applied to detect change points according to some embodiments of the present invention.

### DETAILED DESCRIPTION

In the following description, details of the present invention are set forth as preferred embodiments. It will be apparent to those skilled in the art that modifications, including additions and/or substitutions may be made without departing from the scope and spirit of the invention. Specific details may be omitted for the sake of conciseness. However, the disclosure is written to enable one skilled in the art to practice the teachings herein without undue experimentation.

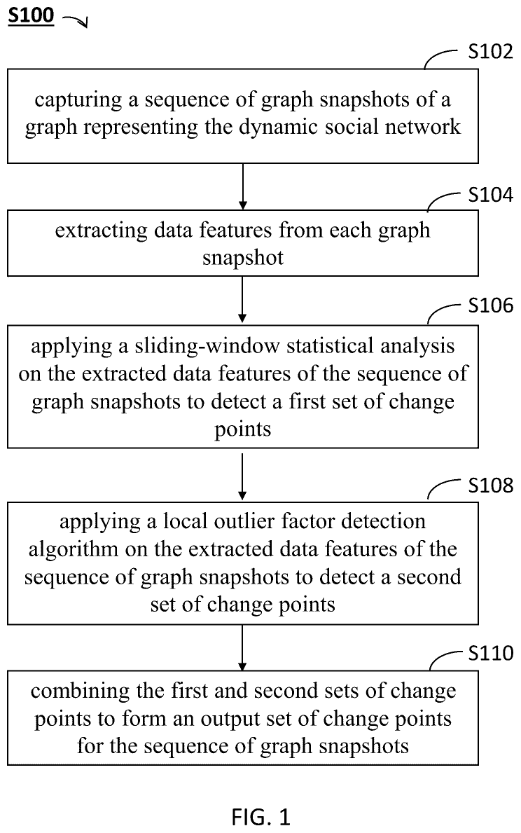

FIG. 1 shows a process flowchart of a machine-learning method S100 for detecting data change points in a dynamic social network according to some embodiments of the present invention. The method S100 includes the following major steps:
S102: capturing a sequence of graph snapshots of a graph representing the dynamic social network.
S104: extracting data features from each graph snapshot;
S106: applying a sliding-window statistical analysis on the extracted data features of the sequence of graph snapshots to detect a first set of change points;
S108: applying a local outlier factor detection algorithm on the extracted data features of the sequence of graph snapshots to detect a second set of change points;
S110: combining the first and second sets of change points to form an output set of change points for the sequence of graph snapshots.

In the step S102, the dynamic network is represented as a series of graphical snapshots denoted as G⁽¹⁾, G⁽²⁾, . . . , where each snapshot G^{(t)} represents an undirected weighted graph with different nodes observed at discrete time. The adjacency matrices of the graph snapshot G^{(t)} are denoted as X^{(t)}.

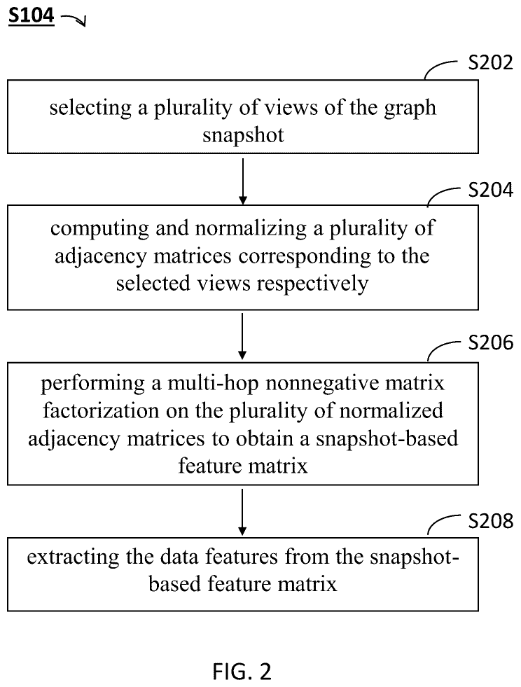

In the step S104, referring to FIG. 2, the data features are extracted by performing the following steps:
S202: selecting a plurality of views of the graph snapshot;
S204: computing and normalizing a plurality of adjacency matrices, denoted as X M, corresponding to the selected views respectively;
S206: performing a multi-hop nonnegative matrix factorization on the plurality of normalized adjacency matrices to obtain a snapshot-based feature matrix; and
S208: extracting the data features from the snapshot-based feature matrix.

In the step S202, different connection patterns under varying hop counts are considered to construct distinct network views. Based on the six degrees of separation theory, the entries in the k-th power of the adjacency matrix have a specific meaning: they represent the total number of paths of length k between node pairs in graph G. Simultaneously, they directly reflect the k-order interaction strength between nodes i and j. Therefore, the connection patterns of all node pairs can be described on basis of the six degrees of separation theory and the number of views to be selected may be determined under the constraint expressed as:

$${d}_{0} = min ( diam ( G ) , 6 ) , \qquad ( 1 )$$

Where d₀ is the total number of views that we need and diam(G) represents the maximum number of views in snapshot G.

In the step S204, as expressed in formula (2), the normalization is performed on the adjacency matrices to map them to the interval [0,1], ensuring their non-negativity while scaling different view matrices to the same size. Additionally, since non-negative matrices possess numerous favorable properties, this normalization step allows us to preserve specific physical meanings during subsequent optimization processes.

$$A = \frac{A - {A}_{m i n}}{{A}_{m ax} - {A}_{m i n}} , \qquad ( 2 )$$

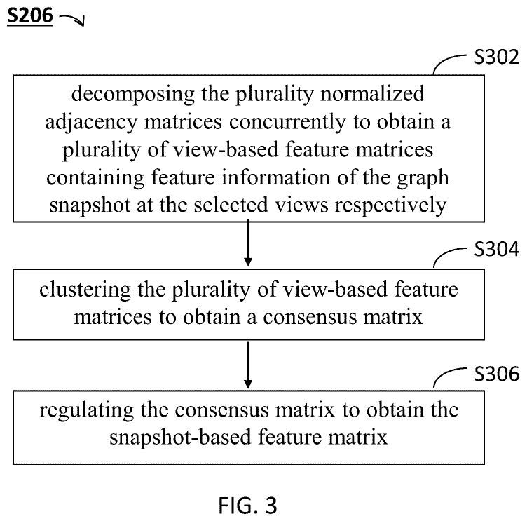

In the step S206, referring to FIG. 3, the multi-hop nonnegative matrix factorization is performed to obtain the snapshot-based feature matrix by performing the following steps:
S302: decomposing the plurality normalized adjacency matrices concurrently to obtain a plurality of view-based feature matrices containing feature information of the graph snapshot at the selected views respectively;
S304: clustering the plurality of view-based feature matrices to obtain a consensus matrix; and
S306: regulating the consensus matrix to obtain the snapshot-based feature matrix.

In the step S302, For the input normalized matrix A, we will perform matrix decomposition by combining different views. Given a network G, Symmetric NMF attempts to decompose the adjacency matrix A (A∈R^{n×n}) using two identical factor matrices. This matrix decomposition method classifies the node information in the graph, which is reflected in the matrix H (H∈R^{n×k}). The Symmetric NMF method serves as a fundamental building block for the subsequent MHNMF matrix decomposition method. Obviously, the reconstructed factor matrices need to be as close as possible to the original adjacency matrix A, and to ensure that the decomposed matrices are non-negative, we impose the following constraints, as shown in formula (3).

$${min}_{H} {‖ {HH}^{T} - A ‖}_{F}^{2} \qquad ( 3 )$$

$$s . t . H \geq 0 ,$$

In one embodiment, each adjacency matrix is decomposed into two identical factor matrices through symmetric nonnegative matrix factorization under the optimization objective that the reconstructed factor matrices need to be as close as possible to the original adjacency matrix, and to ensure that the decomposed matrices are non-negative.

Through such matrix decomposition, the classified node information in the graph is reflected in the factor matrix which can be taken as a view-based feature matrix.

In the step S304, the view-based feature matrices are clustered under a clustering optimization objective to minimize distances between a clustering center and the plurality of view-based feature matrices. Then the clustering center of the clustered view-based feature matrices is taken as the consensus matrix. Multiview NMF aims to simultaneously decompose different data views through matrix decomposition and find a consensus representation matrix among all views. It serves as a fundamental building block for the later mentioned MHNMF matrix decomposition method. The objective of Multiview NMF is to optimize formula (4).

In one embodiment, the clustering optimization objective is given by:

$${min}_{{H}^{( v )} , {H}^{\text{(*} )}} {\sum }_{v = 1}^{{n}_{v}} {‖ {A}^{( ν )} - {H}^{( ν )} {H}^{{( ν )}^{T}} ‖}_{F}^{2} {\sum }_{v = 1}^{{n}_{v}} {λ}_{v} {‖ {H}^{( ν )} - {H}^{{(}^{*} )} ‖}_{F}^{2} , \qquad ( 4 )$$

$$s . t . {H}^{( ν )} , {H}^{{(}^{*} )} \geq 0$$

Where λᵥ's are hyperparameters used to control the importance of different data views, H^{(v)}∈R^{d×k} and H^{(*)} E R^{n×k}, represents consensus representation matrix. Adding non negativity to H^{(v)} and H^{(*)} can enhance its properties, interpretability, and applicability.

In the step S306, the consensus matrix is regulated under a regulation optimization objective to minimize a trace function of the consensus matrix.

In one embodiment, Through the method of graph regularization, the decomposed matrix can preserve their geometric structures, and this approach enables nodes with high similarity to be grouped into the same community. According to spectral theory, one way to achieve this functionality is by optimizing formula (5).
and given by:

$${min}_{H} {\sum }_{i , j = 1}^{n} {s}_{i j} {‖ \frac{{h}^{i}}{\sqrt{{d}_{i}}} - \frac{{h}^{j}}{\sqrt{{d}_{j}}} ‖}_{F}^{2} = 2 Tr ( {H}^{T} LH ) , \qquad ( 5 )$$

where dᵢ=sⁱ1ₙ, H∈R^{n×k} is a matrix containing node classification information, L=Iₙ−\tilde{S} is the normalized Laplacian matrix of S, where \tilde{S}=diag(S1ₙ)^{-1/2}Sdiag(S1ₙ)^{-1/2} is the normalized similarity matrix of S. Here, hⁱ represent the column of H. sᵢⱼ rerepresents the elements on the ith row and jth column of H.

The obtained view-based feature matrices are normalized to unify the scales of all views to ensure that the information from different views is appropriately weighted and combined to obtain a comprehensive representation of the node classification. The obtained view-based feature matrices may be further adjusted by controlling the importance of graph regularization. Meanwhile, we will discuss its extension to dynamic networks, with the addition of time t(t∈[1, T]). Ultimately, a joint optimization model for MHNMF, as shown in formula (6), is arrived to obtain the snapshot-based feature matrix Hₜ^{(*)} that encapsulates the assigned node information of all the views in the graph snapshot and represents the classification or clustering of nodes in the graph.

$${min}_{{{H}_{t}^{( v )} , α}_{{H}_{t}^{\text{(*} )} , μ}} {\sum }_{ν = 1}^{{d}_{0}} {‖ {A}_{t}^{( ν )} - {H}_{t}^{( ν )} {H}_{t}^{{( v )}^{T}} ‖}_{F}^{2} + {λ}_{t}^{v} {\sum }_{ν = 1}^{{d}_{0}} {‖ {H}_{t}^{{(}^{*} )} - {H}_{t}^{( ν )} ‖}_{F}^{2} + {ω}_{t} Tr ( {H}_{t}^{{{(}^{*} )}^{T}} ( {\sum }_{ν = 1}^{{d}_{0}} {u}_{v}^{( t )} {L}_{t}^{( ν )} ) {H}_{t}^{{(}^{*} )} ) + η ( {‖ α ‖}_{2}^{2} + {‖ μ ‖}_{2}^{2} ) \qquad ( 6 )$$

$$s . t . {H}_{t}^{( ν )} \geq 0 , {H}_{t}^{{(}^{*} )} \geq 0 , α \geq 0 , {α}^{T} {1}_{{d}_{0}} = 1 , μ \geq 0 , {μ}^{T} {1}_{{d}_{0}} = 1 ,$$

where Hₜ^{(*)}≥0 and Hₜ^{(*)}∈R^{n×k} captures the matrix of information between n odes of all the views. α^{T}1_{d}_{₀} (to avoid trivial solutions) and

$$α ∈ {Δ}^{{d}_{0}} ( {Δ}^{{d}_{0}} = \{ x ∈ {R}^{d} \vert x \geq 0 , {\sum }_{i = 1}^{d} {x}_{i} = 1 \} )$$

is a parameter vector controlling the importance of different views, and η is a parameter to control the smoothness of α. ωₜ is used to adjust the importance of graph regularization, and for simplicity, q is used to simultaneously adjust the importance of smoothing α and μ.

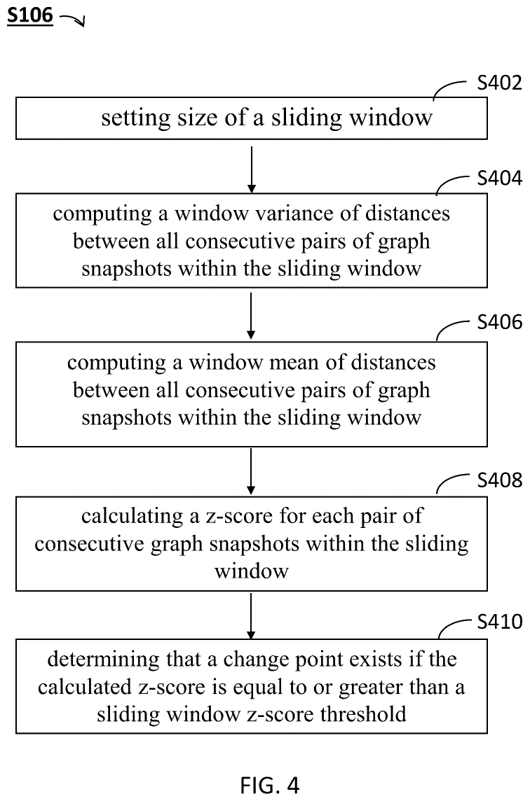

In the step S106, referring to FIG. 4, the sliding-window statistical analysis is applied to detect the first set of change points by performing the following steps:
S402: setting size of a sliding window;
S404: computing a window variance of distances between all consecutive pairs of graph snapshots within the sliding window;
S406: computing a window mean of distances between all consecutive pairs of graph snapshots within the sliding window;
S408: calculating a z-score for each pair of consecutive graph snapshots within the sliding window;
S410: determining that a change point exists if the calculated z-score is equal to or greater than a sliding window z-score threshold.

Since the dimensions of the allocated matrices of different graph snapshots may be inconsistent, zeros are padded to the smaller matrix to make the dimensions of both matrices consistent. That is, for matrices with a small number of nodes, to measure such differences, it can be achieved by adding isolated nodes. Clearly, these isolated nodes have no relationship with each other or with other nodes, therefore, the information in all matrices containing isolated nodes should be zero.

In the step S402, Measure the distance between snapshots at different times by calculating the Frobenius norm of two snapshots at t₁ and t₂. as expressed in formula (7).

$${δ}_{F}^{{t}_{1} {t}_{2}} ( {H}_{{t}_{1}}^{{(}^{*} )} , {H}_{{t}_{2}}^{{(}^{*} )} ) = {‖ {H}_{{t}_{1}}^{{(}^{*} )} - {H}_{{t}_{2}}^{{(}^{*} )} ‖}_{F} = \sqrt{{\sum }_{i = 1}^{m} {\sum }_{j = 1}^{n} {( {x}_{i j}^{{t}_{1}} - {y}_{i j}^{{t}_{2}} )}^{2}} , \qquad ( 7 )$$

After measuring the distance between two consecutive snapshots, the size of the sliding window is set. We need to set different window sizes for different datasets, mainly based on the size of t, usually around 2-4.

In the step of S408, the Z-score is calculated by statistically analyzing the parameters within the slide window as expressed in formula (8).

$${Z}_{j} = \frac{\vert {δ}_{F}^{{t}_{1} {t}_{2}} ( X , Y ) - {Windows}_{avg} \vert}{W i n d o w {s}_{s t d}} \qquad ( 8 )$$

Where Windows, and Windows, are the variance and mean of the distances between two consecutive snapshots within the sliding window, respectively. By calculating the Z-score for each time period, we set a quantile q to determine the change points. For a series of k graph snapshots, the top q % of graph snapshots based on their Z-scores are determined as the first set of change points.

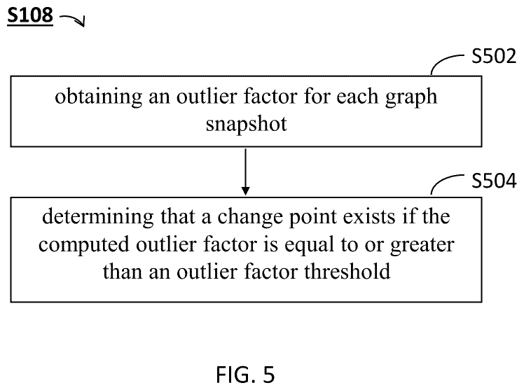

In the step of S108, referring to FIG. 5, the local outlier factor detection algorithm is applied to detect the second set of change points by performing the following steps:
S502: obtaining an outlier factor for each graph snapshot; and
S504: determining that a change point exists if the computed outlier factor is equal to or greater than an outlier factor threshold.

In the step S502, a local reachability density for each graph snapshot (or data point) is calculated based on the density of graph snapshots in its surroundings. The outlier factor is then calculated based on the calculated local reachability density.

The outlier factor indicates the degree of outlierness of the graph snapshot, where a higher factor value represents a higher degree of outlierness, and a lower factor value represents a lower degree of outlierness.

In the step S504, all graph snapshots based on their outlier factor scores and output the n graph snapshots with the highest outlier scores as the second set of change points.

The machine-learning method for detecting data change points in a dynamic social network in accordance with embodiments disclosed herein may be implemented using computing devices, computer processors, or electronic circuitries including but not limited to application specific integrated circuits (ASIC), field programmable gate arrays (FPGA), and other programmable logic devices configured or programmed according to the teachings of the present disclosure. Computer instructions or software codes running in the computing devices, computer processors, or programmable logic devices can readily be prepared by practitioners skilled in the software or electronic art based on the teachings of the present disclosure.

All or portions of the methods in accordance with the embodiments may be executed in one or more computing devices including server computers, personal computers, laptop computers, mobile computing devices such as smartphones and tablet computers.

The embodiments include computer storage media having computer instructions or software codes stored therein which can be used to program computers or microprocessors to perform any of the processes of the present invention. The storage media can include, but are not limited to, floppy disks, optical discs, Blu-ray Disc, DVD, CD-ROMs, and magneto-optical disks, ROMs, RAMs, flash memory devices, or any type of media or devices suitable for storing instructions, codes, and/or data.

Each of the functional units in accordance with various embodiments also may be implemented in distributed computing environments and/or Cloud computing environments, wherein the whole or portions of machine instructions are executed in distributed fashion by one or more processing devices interconnected by a communication network, such as an intranet, Wide Area Network (WAN), Local Area Network (LAN), the Internet, and other forms of data transmission medium.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

What is claimed is:

1. A machine-learning method for detecting data change points in a dynamic social network, comprising:
capturing a sequence of graph snapshots of a graph representing the dynamic social network;
extracting data features from each graph snapshot;
applying a sliding-window statistical analysis on the extracted data features of the sequence of graph snapshots to detect a first set of change points;
applying a local outlier factor algorithm on the extracted data features of the sequence of graph snapshots to detect a second set of change points;
combining the first and second sets of change points to form an output set of change points for the sequence of graph snapshots;
wherein the data features are extracted from each graph snapshot by:
selecting a plurality of views of the graph snapshot;
computing and normalizing a plurality of adjacency matrices corresponding to the selected views respectively;
performing a multi-hop nonnegative matrix factorization on the plurality of normalized adjacency matrices to obtain a snapshot-based feature matrix; and
extracting the data features from the snapshot-based feature matrix.

2. The method according to claim 1, wherein the multi-hop nonnegative matrix factorization is performed to obtain the snapshot-based feature matrix by:
decomposing the plurality normalized adjacency matrices concurrently to obtain a plurality of view-based feature matrices containing feature information of the graph snapshot at the selected views respectively;
clustering the plurality of view-based feature matrices to obtain a consensus matrix; and
regulating the consensus matrix to obtain the snapshot-based feature matrix.

3. The method according to claim 2, wherein the plurality of view-based feature matrices is obtained by:
concurrently decomposing each of the plurality of normalized adjacency matrices into a pair of identical factor matrices under a decomposition optimization objective to minimize distance between the normalized adjacency matrix and a reconstruction matrix obtained by multiplying the pair of factor matrices; and
determining the optimized factor matrices as the view-based feature matrices.

4. The method according to claim 2, wherein the consensus matrix is obtained by:
clustering the plurality of view-based feature matrices under a clustering optimization objective to minimize distances between a clustering center and the plurality of view-based feature matrices; and
determining the clustering center of the clustered view-based feature matrices as the consensus matrix.

5. The method according to claim 4, wherein the consensus matrix is regulated under a regulation optimization objective to minimize a trace function of the consensus matrix.

6. The method according to claim 1, wherein the views are selected based on the six degrees of separation theory.

7. The method according to claim 1, wherein the first set of change points are detected by:
setting size of a sliding window;
computing a window variance of distances between all consecutive pairs of graph snapshots within the sliding window;
computing a window mean of distances between all consecutive pairs of graph snapshots within the sliding window;
calculating a z-score for each pair of consecutive graph snapshots within the sliding window; and
determining that a change point exists if the calculated z-score is equal to or greater than a sliding window z-score threshold.

8. The method according to claim 7, wherein the z-score for each pair of consecutive graph snapshots within the sliding window is calculated by:
determining a Euclidean norm of distance between the pair of consecutive graph snapshots; and
using the determined Euclidean norm of distance, the computed window variance and the computed window mean to calculate the z-score.

9. The method according to claim 1, wherein the second set of change points are detected by:
obtaining an outlier factor for each graph snapshot; and
determining that a change point exists if the computed outlier factor is equal to or greater than an outlier factor threshold.

10. The method according to claim 9, wherein the outlier factor for each graph snapshot is obtained by:
calculating a local reachability density for the graph snapshot; and
computing the outlier factor based on the calculated local reachability density.
